(19) United States
(12) Patent Application Publication
(10) Pub. No.: US 2025/0276332 A1
(43) Pub. Date: Sep. 4, 2025

(54) MIST EMITTING DEVICE

(71) Applicant: Ross Lifescience USA Inc., Lorton, VA (US)

(72) Inventors: Arumugham MAHENDRAN, Maharashtra (IN); Srinivasan SRIDHAR, Maharashtra (IN); Pavana NAIR, Maharashtra (IN); K.J. GANESH MURUGAN, Maharashtra (IN); Amol POTDAR, Maharashtra (IN)

(21) Appl. No.: 19/066,397

(22) Filed: Feb. 28, 2025

(30) Foreign Application Priority Data
Feb. 29, 2024 (IN) 202421015150

(51) Int. Cl. B05B 1/10; A01M 1/20; B05B 17/06

(52) U.S. Cl. CPC B05B 1/10; A01M 1/205; B05B 17/0607

(57) ABSTRACT

A portable and compact mist emitting device for disperse a fluid mist into a target surrounding space. The mist emitting device includes a bottom housing having a recessed portion adapted to receive a replaceable fluid reservoir storing a liquid, a liquid conveying member having a first end positioned in the fluid reservoir and a second end extending from the recessed portion in a direction away from the fluid reservoir. The liquid conveying member conveys the liquid stored in the fluid reservoir towards the second end by capillary action. An atomizer is coupled with the liquid conveying member to convert the liquid present at the second end of the liquid conveying member into mist particles.

### FIELD OF DISCLOSURE

The present disclosure relates to the field of fluid spraying devices. More particularly, the present disclosure relates to a portable mist emitting device configured to disperse a fluid mist into surroundings.

### BACKGROUND

Background description includes information that may be useful in understanding the present invention. It is not an admission that any of the information provided herein is prior art or relevant to the presently claimed invention, or that any publication specifically or implicitly referenced is prior art.

Problems associated with the presence of mosquitoes and other flying insects are well known, particularly during summer months when people typically engage in many outdoor activities. People have long appreciated the dangers associated with mosquito-borne diseases such as malaria and equine encephalitis. In addition, people are generally aware of the pain, discomfort and potentially dangerous allergic reactions that can accompany bites of various flying and crawling insects encountered outdoors in either urban or rural areas.

Various chemical sprays and devices have previously been used to control flying and crawling insects, spiders, and other such pests. Chemical sprays containing environmentally acceptable concentrations of insecticides or pesticides have historically been applied using hand-held sprayers, fogging machines, electric sprayers and the like. In most rural settings, sprayer systems have previously been used to spray insecticides or pesticides in and around barns, livestock holding areas, and the like.

Such conventional spraying devices for controlling insects and pests require continuous electrical power supply for operation. Also, such spraying devices fail to perform their intended function of repelling insects or pests during irregular supply of electrical power, thereby severely affecting portability of such devices. In addition, the conventional spraying devices, such as mosquito repelling devices, typically transpire a volatile fluid into surroundings in the form of a liquid to eliminate or repel the insects or pests outside the surroundings. However, dispersion of the volatile fluid in the liquid form often results in respiratory disorders, such as nausea, cough, sore throat, etc., of human beings located in proximity thereof.

Some commercially available insect repellent devices use positive thermistor heaters to evaporate a liquid through a wick and disperse the evaporated liquid into the surroundings. Unfortunately, such devices require heavy electrical energy and take longer time for dispersal of the evaporated liquid. Such devices fail to provide an instant and portable solution. Alternatively, aerosols/liquids can be used to eliminating or repelling insects or pests. However, aerosols/liquids are generally unsafe to inhale by human beings, as they contain pressurized liquid. Also, aerosol generating devices or liquid vaporizing devices are relatively expensive than conventional insect repellent devices.

As described above, the current insect repellent devices have proven cumbersome and unwieldy and there has been a long-felt need for an improved fluid spraying device for efficiently transpiring a fluid into surroundings. Further, there is a need in the art to improve portability, reliability and cost characteristics of such fluid spraying devices.

### SUMMARY

An object of the present disclosure is to provide a mist emitting device for dispersing or transpiring a fluid into a target space in the form of fine mist particles.

Another object of the present disclosure is to provide a compact and lightweight mist emitting device suitable for deodorization, air freshening, insect repellent, malodour removal and other aromatherapy applications.

Another object of the present disclosure is to provide a portable and cost-efficient mist emitting device that prevents the requirement of continuous electrical power supply.

Another object of the present disclosure is to provide a smart mist emitting device configured to efficiently disperse mist particles of the liquid into the target space, while reducing an amount of the liquid required for generating a specific amount of mist particles, when compared to conventional spraying devices.

Another object of the present disclosure is to provide a fast-action mist emitting device for dispersing the mist particles into the target space intermittently upon actuation.

Another object of the present disclosure is to provide a safe mist emitting device capable of effectively preventing exposure of human beings to the liquid used for generating the mist particles.

The present disclosure relates to liquid spraying devices capable of dispersing a liquid into a surrounding space. An aspect of the present disclosure pertains to a mist emitting device for dispersing or spreading fine mist particles into a surrounding space. The mist emitting device includes a bottom housing having a recessed portion adapted to receive a replaceable fluid reservoir storing a liquid, and a liquid conveying member having a first end positioned in the fluid reservoir and a second end extending from the recessed portion in a direction away from the fluid reservoir. The liquid conveying member is configured to convey the liquid stored in the fluid reservoir towards the second end by capillary action. The liquid conveying member may be a wick. The mist emitting device also includes an atomizer coupled with the liquid conveying member to convert the liquid present at the second end of the liquid conveying member into mist particles. The atomizer may include an ultrasonic atomization transducer configured to oscillate at a pre-determined frequency.

### EMBODIMENTS

In some embodiments, the mist emitting device may include a top housing to be fitted with the bottom housing. The top housing may include one or more ports for dispersing the mist particles generated by the atomizer into a target space.

In some embodiments, the mist emitting device may include an atomizer control unit configured to control the atomizer to convert the liquid present at the second end of the liquid conveying member into mist particles based on actuation of a switch. The atomizer control unit may include a power supply unit connected to a battery pack. The power supply unit may be configured to supply discharge energy of the battery pack to the atomizer control unit to control the atomizer based on actuation of the switch. The power supply unit and the battery pack may be accommodated within an enclosure formed by fitting of the top housing with the bottom housing.

In some embodiments, the power supply unit may supply electric energy from an external power source to the atomizer control unit to control the atomizer. In another embodiment, the power supply unit may be configured to control charging of the battery pack by the external power source.

In some embodiments, the atomizer may be positioned within an atomizer housing, which includes an atomizer housing cap for biasing the atomizer towards the second end of the liquid conveying member by a biasing member disposed between the atomizer housing cap and the atomizer. The biasing member may be a spring.

In some embodiments, the liquid stored in the fluid reservoir may be a volatile liquid having a pre-determined concentration of a volatile substance. The volatile liquid may be suitable for repelling insects and pests from the target space.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a front view of a replaceable fluid reservoir adapted to be fitted with a mist emitting device in accordance with an embodiment of the present invention;

FIG. 2 illustrates an exploded view of the mist emitting device in accordance with an embodiment of the present invention; and

FIGS. 3A through 3E illustrate various views of the mist emitting device, in accordance with an embodiment of the present invention.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure relates to a smart and portable liquid spraying device for dispersing a liquid into a surrounding space in the form of fine mist particles. The liquid spraying device (also referred to as “mist emitting device” hereinafter) is compact and lightweight, and is suitable for deodorization, air freshening, insect repellent, malodour removal and other aromatherapy applications. The mist emitting device efficiently disperse mist particles of the liquid into a target surrounding space, and reduces an amount of liquid required for generating a specific amount of mist particles, when compared to conventional spraying devices.

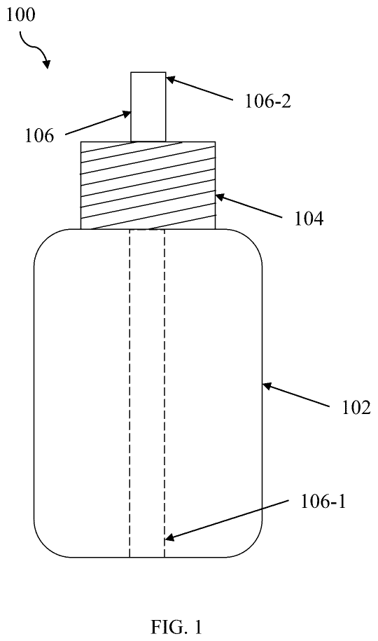

FIG. 1 illustrates a front view of a replaceable fluid reservoir 100 adapted to be fitted with the mist emitting device of the present invention. The fluid reservoir 100 stores a liquid, and may be detachable fitted with the mist emitting device. The fluid reservoir 100 may include a chamber 102 for storing a pre-determined amount of the liquid, and a threaded cap 104 for fitment with the mist emitting device. The chamber 102 may be refillable to ensure continuous supply of the liquid to the mist emitting device. The fluid reservoir 100 may be provided with a liquid conveying member 106, such as a wick, having a first end 106-1 positioned within the chamber 102 and a second end 106-2 extending outwards from the chamber 102. The liquid conveying member 106 may be formed of a porous absorbent material, and configured to convey or direct the liquid stored in the chamber 102 towards its second end 106-2 by capillary action. The threaded cap 104 may include a plug stopper for fixing position of the liquid conveying member 106 with the container 102.

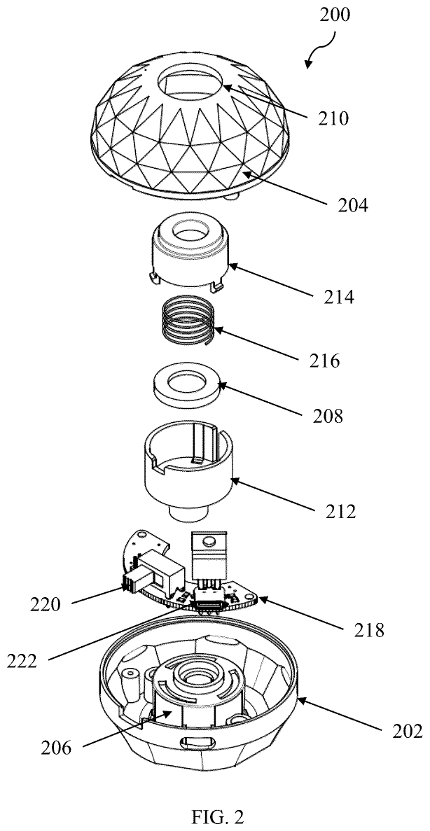

FIG. 2 illustrates an exploded view of the mist emitting device 200, which includes a bottom housing 202 and a top housing 204 adapted to be coupled to one another to form a housing for accommodating other components of the mist emitting device 200. The bottom housing 202 and the top housing 204 may be fitted together by plug-in, snap fitting, threaded engagements or other suitable fitting techniques. The bottom housing 202 includes a recessed portion 206 extending towards the top housing 204. The recessed portion 206 may be adapted to receive the replaceable fluid reservoir 100, as shown in FIG. 1. The recessed portion 206 may include a threaded portion having internal threads for engaging the threaded head 104 of the fluid reservoir 100, when the fluid reservoir 100 is to be fitted to the recessed portion 206.

The fluid reservoir 100 is detachable fitted to the recessed portion 206 such that the second end 106-2 of the liquid conveying member 106 extends through the recessed portion 206 in a direction away from the fluid reservoir 100. The mist emitting device 200 also includes an atomizer 208 coupled with the liquid conveying member 106 so as to convert the liquid directed to the second end 106-2 of the liquid conveying member 106, by the capillary action, into fine mist particles. The atomizer 208 may be positioned in vicinity of the second end 106-2 of the liquid conveying member 106 to efficiently convert the liquid present at the second end 106-2 into mist particles.

The atomizer 208 may include an ultrasonic atomization transducer configured to oscillate at a pre-defined frequency. When the second end 106-2 of the liquid conveying member 106 comes in contact with the atomizer 208, the liquid present at the second end 106-2 is atomized due to the vibration of the ultrasonic atomization transducer, resulting in generation of fine mist particles. The top housing 204 may include one or more ports 210 appropriately positioned to disperse or emit the mist particles generated by the atomizer 208 into a target surrounding space.

In an example, the liquid stored in the fluid reservoir may be a volatile liquid having a pre-determined concentration of a volatile substance. The volatile liquid may be suitable for repelling insects and pests from the target surrounding space. The pre-determined concentration of the volatile substance in the volatile fluid may be selected based on safety standards pertaining to the volatile substance, to ensure that emission of the volatile liquid does not affect health of human beings present in the target surrounding space. The mist emitting device 200, thus, effectively prevents exposure of human beings to the volatile liquid used for generating the mist particles for eliminating or repelling insects and pests from the target surrounding space. The mist emitting device 200 prevents the requirement of heating elements to vaporize the volatile liquid stored in the fluid reservoir 100, to improve safety as well as reliability thereof. In another example, the liquid stored in the fluid reservoir may be a fragrance liquid having a pre-determined concentration of a fragrance material, to allow emission of the fragrance liquid into the target surrounding space in the form of fine mist particles.

The mist emitting device 200 may include an atomizer housing 212 for accommodating the atomizer 208. The atomizer housing 212 may be disposed over the recessed portion 206 of the bottom housing 202. The atomizer housing 212 may include an external flange adapted to be fitted into a slot of the recessed portion 206. The atomizer housing 212 in a fitted position over the recessed portion 206 may receive the second end 106-2 of the liquid conveying means 106, to enable the second end 106-2 to be positioned in vicinity of the atomizer 208. In an implementation, the atomizer 208 may encircle the second end 106-2 of the liquid conveying means 106, to efficiently atomize the liquid present at the second end 106-2.

The atomizer housing 212 may include a cap 214 adapted to bias the atomizer 208 towards the second end 106-2 of the liquid conveying means 106 and prevent any undesired movement of the atomizer 208. A biasing member 216, such as a helical spring, a coil spring, a torsion spring, and the like, may be positioned between the atomizer 208 present within the atomizer housing 212 and the cap 214 to bias the atomizer 208 towards the second end 106-2 of the liquid conveying means 106. The cap 214 may include an internal flange for supporting an end of the biasing member 216, with the other end of the biasing member 216 located in the atomizer 208.

The mist emitting device 200 may include an atomizer control unit 218 configured to control an atomization operation of the atomizer 208 for converting the liquid present at the second end 106-2 of the liquid conveying member 106 into mist particles based on actuation of a switch 220 thereof. The atomizer control unit 218 may be configured to start the atomization operation of the atomizer 208 for generation of the fine mist particles after a pre-set time delay after manual actuation of the switch 220 by a user. In an implementation, the pre-set time delay may in the order of 1-100 milliseconds. Thus, the atomizer 208 enables the mist emitting device 200 to intermittently generate and disperse the fine mist particles into the target surrounding space in a substantially reduced time interval, when compared to conventional liquid spraying devices. The atomizer 208 may include an ultrasonic atomization transducer configured to vibrate at a pre-set frequency to ensure fast action of the smart mist emitting device 200 by reducing a time interval required for atomization of the liquid present at the second end 106-2 of the liquid conveying member 106 into fine mist particles. Since the liquid is atomized instantly, the action of vaporization is instant and intermittently spreads to the target surrounding space in the form of mist particles.

The ultrasonic atomization transducer reduces liquid consumption and over-dispersal of the mist particles. This enables the mist emitting device 200 to exhibit high release of the mist particles within a reduced time, while reducing an amount of the liquid required for generating a specific amount of mist particles, when compared to conventional liquid spraying devices. The ultrasonic atomization transducer also enables highly controllable spray patterns with ultra-low flow rate capabilities to be generated, requires low maintenance and has reduced downtime. In this way, the atomizer control unit 218 may control the atomization operation of the atomizer 208 to continuously generate mist particles after actuation of the switch 220. Additionally or alternatively, the atomizer control unit 218 may include a timer to facilitate generation of the mist particles at different time intervals after actuation of the switch 220. The atomizer control unit 218 enables the mist emitting device 200 to intelligently control the atomization operation of the atomizer 208 to generate and emit the fine mist particles in the target space with enhance operability, and may be employed in applications, including deodorization, air freshening, insect repellent, malodour removal and other aromatherapy applications.

The switch 220 may be adapted to move between an open position to interrupt or halt the atomization operation of the atomizer 208, a closed position to initiate the atomization operation of the atomizer 208. The atomizer control unit 218 may include any of a controller, a microcontroller, and an Integrated Circuit (IC) chip, formed on a Printed-Circuit Board (PCB) to control the atomization operation of the atomizer 208. The PCB may be positioned within an enclosure formed by fitment of the top housing 204 with the bottom housing 202. The PCB may be arranged within the enclosure to encircle the recessed portion 206. The bottom housing 202 may include a plurality of bosses for securely accommodating the PCB with the help of fasteners, such as screws, pins, bolts, and the likes. This configuration of the atomizer control unit 218 positioned within the enclosure results in a compact and lightweight mist emitting device 200.

The atomizer control unit 218 may include a power supply unit connected to a rechargeable battery pack. The rechargeable battery pack may be include one or more batteries selected as any or a combination of lithium ion batteries, alkaline batteries and lead acid batteries. The power supply unit may be configured to supply discharge energy of the battery pack to the atomizer control unit 218 to control the atomization operation of the atomizer 218 based on actuation of the switch 220 by a user. The power supply unit may be configured to supply electric energy from an external power source, such as but not limited to standard household AC power source, to the atomizer control unit 218 to control the atomization operation of the atomizer 208. Additionally or alternatively, the power supply unit may be configured to control charging of the battery pack by the external power source. The atomizer control unit 218 ensures that the mist emitting device 200 is portable and prevents the requirement of a continuous supply of electric power from the external power source. The atomizer control unit 218 also enhances operability of the mist emitting device 200 by allowing the mist emitting device 200 to reliably operate in remote locations, such as outdoors, even in absence of the external power source. In an embodiment, the battery pack may be positioning within the smart mist emitting device 200. The power supply unit and the battery pack may be accommodated within an enclosure formed by fitting of the top housing 204 with the bottom housing 202. In another embodiment, the battery pack may be externally provided to the smart emitting device 200.

The power supply unit may include an input/output (I/O) port 222 for controlling supply of the electric energy from the external power source to the atomizer control unit 218 and/or the battery pack. The I/O port 222 may be provided with a connector module, such as micro-USB connector module, USB-C connector module, or a proprietary connector module, for controlling transmission of electrical and communication signals between the power supply unit and the external power source.

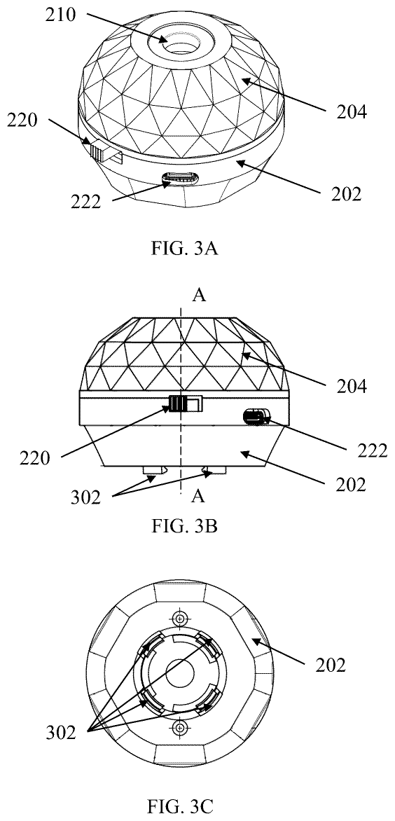

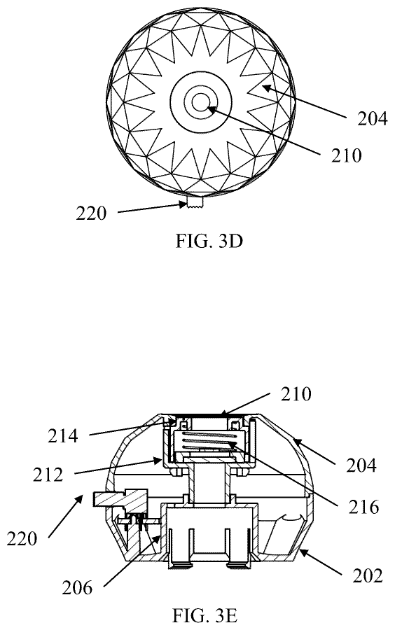

FIGS. 3A and 3B show a perspective view and a side view of the mist emitting device 200, respectively. FIGS. 3C and 3D illustrate a bottom view and a plan view of the mist emitting device 200, respectively. FIG. 3E shows a cross-sectional view of the mist emitting device 200 across section A-A depicted in FIG. 3B. The bottom housing 202 may be provided with a plurality of protrusions 302 extending downwards from a bottom surface thereof. The protrusions 302 may act as guides for facilitating fitment of the fluid reservoir 100 to the recessed portion 206 of the bottom housing 202.

### Experimental Results

To validate performance and reliability of the mist emitting device 200, bio-efficacy of the mist emitting device 200 was tested with respect to conventional liquid vaporizing devices for various types of liquid formulations.

### Example 1: Liquid Formulations

TABLE 1
Liquid Formulations of Transfluthrin and Pogostemon cablin

| | Role in | Formulation | Formulation |
|---|---|---|---|
| Ingredients | formulation | 1 (wt. %) | 2 (wt. %) |
| Transfluthrin | Pesticide | 1.6 | — |
| Pogostemon cablin | Pesticide | — | 10 |
| (Patchouli) | | | |
| Butylated Hydroxytoluene | Preservative | 1.0 | 1.0 |
| (BHT) | | | |
| Lemon global | Perfume | 1.0 | 1.0 |
| Deodorized Kerosene | Solvent | 96 | 88 |
| Total | | 100 | 100 |

All the ingredients were weighed accurately as per Table 1 above and were properly mixed (except solvent) to obtain a blend in a beaker. The blend was mixed with the solvent to obtain a liquid formulation that can be used directly for controlling various indoor and outdoor pests.

### Bio-Efficacy Study of the Liquid Formulation—a Comparison Between Mist Emitting Device 200 and the Conventional Liquid Vaporizer

The liquid Formulations 1 and 2 realized in Table 1 above were subjected to bio-efficacy studies, particularly, mosquitocidal activity using the Mist emitting device 200 and the conventional liquid vaporizer. The mosquitocidal activity was determined by using a Peet Grady Chamber. The Peet Grady Chamber is a 5.8 m³ chamber having all 5 sides made up of glass with glazy tile flooring. At the bottom left side, there is a small window of 0.5×0.5 ft. for releasing insects in the chamber. Apart from this, it has a door on one wall and four 2-inch diameter holes on each wall placed at a distance of 1.4 m from the ground and in the centre of the wall. These holes are used for dispensing test products inside the chamber. During experimentation, the holes, door, and small window, all were in closed condition. For consistency and reproducibility of results, the environmental conditions viz. temperature of 27±3° C. and Relative Humidity of about 70-80% were maintained. Before evaluating the mosquitocidal activity of Formulations 1 and 2, the Culex quinquefasciatus mosquitoes were first introduced into the chamber, and de-contamination checks were performed for the first ½ hour. If no knockdown of mosquito(es) was seen, then a fresh lot (100 nos.) of Culex quinquefasciatus mosquitoes was introduced, and Formulations 1 and 2 were released in the chamber by using Mist emitting device 200 and a conventional liquid vaporizer, and the experiment was started. The knockdown of insects was observed every 5 minutes for about 60 minutes. Thereafter, the knocked-down mosquitoes were transferred to a clean container with food of 10% sucrose contained in a cotton swab. The mortality readings were noted after 24 hours. Observations were interpreted in Knock-down times, KT₅₀ and KT₉₀ [KT₅₀ is the time (in minutes) needed to knock down 50% of the mosquito population used for an experiment, and KT₉₀ is the time (in minutes) needed to knock down 90% of the mosquito population used for an experiment] and it is determined by the Probit analysis software. Percent mortality was calculated after 24 hours.

TABLE 2
A comparison of the mosquitocidal activity of
liquid formulations using the Mist emitting device
200 and the conventional liquid vaporizer

| | | KT₅₀ | KT₉₀ |
|---|---|---|---|
| Formulations | Type of delivery device | (in minutes) | (in minutes) |
| Formulation 1 | Mist emitting device 200 | 3 | 10 |
| Formulation 1 | Conventional Liquid | 18 | 29 |
| | Vaporizer | | |
| Formulation 2 | Mist emitting device 200 | 9 | 18 |
| Formulation 2 | Conventional Liquid | 60 | 355 |
| | Vaporizer | | |

As can be seen in Table 2 above, the liquid formulations dispersed by the mist emitting device 200 of the present disclosure (provided in Table 1) exhibits reduced KT₅₀ and KT₉₀ values when compared with conventional liquid vaporizing device that is commercially available. This indicates that the mist emitting device 200 is much more efficient in dispersing the liquid formulations in the target space, and require less time for the dispersal of a specific amount of liquid formulation as compared to the conventional liquid vaporizer device. The results show that the mist emitting device 200 is associated with fast-action characteristics, through which the device 200 able to initiate dispersal of mist in the target space upon actuation of the switch 220 in a substantially reduced time interval when compared to the conventional liquid vaporizer device. Accordingly, it could be concluded that the mist emitting device 200 of the present disclosure exhibits an improved and reliable performance and offers significant improvement in controlling various indoor and outdoor pests as compared to the conventional liquid vaporizer.

Thus, the compact, lightweight, and portable mist emitting device of the present disclosure is designed for various applications such as deodorization, air freshening, insect repellent, malodor removal, and aromatherapy. This cost-efficient device does not require continuous electrical power and efficiently disperses fine mist particles with reduced liquid usage compared to conventional sprayers. The mist emitting device offers fast, intermittent mist emission upon actuation, and ensures safety by preventing human exposure to the liquid used for generating the mist.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A mist emitting device, comprising:
a bottom housing having a recessed portion adapted to receive a replaceable fluid reservoir storing a liquid;
a liquid conveying member having a first end positioned in the fluid reservoir and a second end extending from the recessed portion in a direction away from the fluid reservoir, the liquid conveying member configured to convey the liquid stored in the fluid reservoir towards the second end by capillary action;
an atomizer coupled with the liquid conveying member to convert the liquid present at the second end of the liquid conveying member into mist particles.

2. The mist emitting device as claimed in claim 1, comprising a top housing to be fitted with the bottom housing, the top housing comprising one or more ports for dispersing the mist particles generated by the atomizer into a target space.

3. The mist emitting device as claimed in claim 1, comprising an atomizer control unit configured to control the atomizer to convert the liquid present at the second end of the liquid conveying member into mist particles based on actuation of a switch.

4. The mist emitting device as claimed in claim 3, wherein the atomizer control unit comprises a power supply unit connected to a battery pack, the power supply unit configured to supply discharge energy of the battery pack to the atomizer control unit to control the atomizer based on actuation of the switch.

5. The mist emitting device as claimed in claim 4, wherein the power supply unit is configured to supply electric energy from an external power source to the atomizer control unit to control the atomizer.

6. The mist emitting device as claimed in claim 5, wherein the power supply unit is configured to control charging of the battery pack by the external power source.

7. The mist emitting device as claimed in claim 1, wherein the atomizer comprises an ultrasonic atomization transducer configured to oscillate at a pre-determined frequency.

8. The mist emitting device as claimed in claim 1, wherein the atomizer is positioned within an atomizer housing, the atomizer housing comprising an cap for biasing the atomizer towards the second end of the liquid conveying member by a biasing member disposed between the cap and the atomizer.

9. The mist emitting device as claimed in claim 1, wherein the liquid stored in the fluid reservoir is a volatile liquid having a pre-determined concentration of a volatile substance, the volatile liquid being suitable for repelling insects and pests from the target space.

10. The mist emitting device as claimed in claim 1, wherein the liquid conveying member is a wick.
